(19) United States
(12) Patent Application Publication
(10) Pub. No.: US 2023/0281864 A1
(43) Pub. Date: Sep. 7, 2023

(54) Semantic SLAM Framework for Improved Object Pose Estimation

(71) Applicant: Robert Bosch GmbH, Stuttgart (DE)

(72) Inventors: Yuliang Guo, Palo Alto, CA (US); Xinyu Huang, San Jose, CA (US); Liu Ren, Saratoga, CA (US)

(21) Appl. No.: 17/686,677

(22) Filed: Mar. 4, 2022

(51) Int. Cl. G06T 7/73; G06T 7/246; G06T 7/68; G06T 7/40

(52) U.S. Cl. CPC G06T 7/74; G06T 7/246; G06T 7/68; G06T 7/40; G06T 7/75; G06T 2207/30244; G06T 2207/20132; G06T 2207/20081

(57) ABSTRACT

A computer-implemented system and method for semantic localization of various objects includes obtaining an image from a camera. The image displays a scene with a first object and a second object. A first set of 2D keypoints are generated with respect to the first object. First object pose data is generated based on the first set of 2D keypoints. Camera pose data is generated based on the first object pose data. A keypoint heatmap is generated using the camera pose data. A second set of 2D keypoints is generated with respect to the second object based on the keypoint heatmap. Second object pose data is generated based on the second set of 2D keypoints. First coordinate data of the first object is generated in world coordinates using the first object pose data and the camera pose data. Second coordinate data of the second object is generated in the world coordinates using the second object pose data and the camera pose data. The first object is tracked based on the first coordinate data. The second object is tracked based on the second coordinate data.

### FIELD

This disclosure relates generally to computer vision and machine learning systems, and more particularly to image-based pose estimation for various objects.

### BACKGROUND

In general, there a variety of computer applications that involve object pose estimation with six degrees of freedom (6DoF) such as robotic navigation, autonomous driving, and augmented reality (AR) applications. For 6DoF object pose estimation, a prototypical methodology typically relies on the detection of semantic keypoints that are predefined for each object. However, there a number of challenges with respect to detecting semantic keypoints for textureless or symmetric objects because some of their semantic keypoints may become interchanged. Accordingly, the detection of semantic keypoints for those objects across different frames can be highly inconsistent such that they cannot contribute to valid 6DoF poses under the world coordinate system.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method includes obtaining an image that displays a scene with a first object and a second object. The method includes generating a first set of two-dimensional (2D) keypoints corresponding to the first object. The method includes generating first object pose data based on the first set of 2D keypoints. The method includes generating camera pose data based on the first object pose data. The camera pose data corresponds to capture of the image. The method includes generating a keypoint heatmap based on the camera pose data. The method includes generating a second set of 2D keypoints corresponding to the second object based on the keypoint heatmap. The method includes generating second object pose data based on the second set of 2D keypoints. The method includes generating first coordinate data of the first object in world coordinates using the first object pose data and the camera pose data. The method includes generating second coordinate data of the second object in the world coordinates using the second object pose data and the camera pose data. The method includes tracking the first object in the world coordinates using the first coordinate data. The method includes tracking the second object in the world coordinates using the second coordinate data.

According to at least one aspect, a system includes at least a camera and a processor. The processor is in data communication with the camera. The processor is operable to receive a plurality of images from the camera. The processor is operable to obtain an image that displays a scene with a first object and a second object. The processor is operable to generate a first set of 2D keypoints corresponding to the first object. The processor is operable to generate first object pose data based on the first set of 2D keypoints. The processor is operable to generate camera pose data based on the first object pose data. The camera pose data corresponds to capture of the image. The processor is operable to generate a keypoint heatmap based on the camera pose data. The processor is operable to generate a second set of 2D keypoints corresponding to the second object based on the keypoint heatmap. The processor is operable to generate second object pose data based on the second set of 2D keypoints. The processor is operable to generate first coordinate data of the first object in world coordinates using the first object pose data and the camera pose data. The processor is operable to generate second coordinate data of the second object in the world coordinates using the second object pose data and the camera pose data. The processor is operable to track the first object based on the first coordinate data. The processor is operable to track the second object based on the second coordinate data.

According to at least one aspect, one or more non-transitory computer readable storage media stores computer readable data with instructions that when executed by one or more processors cause the one or more processors to perform a method. The method includes generating a first set of 2D keypoints corresponding to the first object. The method includes generating first object pose data based on the first set of 2D keypoints. The method includes generating camera pose data based on the first object pose data. The camera pose data corresponds to capture of the image. The method includes generating a keypoint heatmap based on the camera pose data. The method includes generating a second set of 2D keypoints corresponding to the second object based on the keypoint heatmap. The method includes generating second object pose data based on the second set of 2D keypoints. The method includes generating first coordinate data of the first object in world coordinates using the first object pose data and the camera pose data. The method includes generating second coordinate data of the second object in the world coordinates using the second object pose data and the camera pose data. The method includes tracking the first object in the world coordinates using the first coordinate data. The method includes tracking the second object in the world coordinates using the second coordinate data.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is a diagram of an example of a system relating to 6DoF pose estimation according to an example embodiment of this disclosure.

FIG. 2 is a diagram of an example of an architecture of a machine learning system that comprises a keypoint network according to an example embodiment of this disclosure.

FIG. 3A is a diagram that provides non-limiting examples of various objects and their corresponding keypoints while distinguishing symmetrical classifications from asymmetrical classifications according to an example embodiment of this disclosure.

FIG. 3B is an enlarged view of an object of FIG. 3A to provide a better view of the 2D keypoints on that object according to an example embodiment of this disclosure.

FIG. 4 is a flow diagram of a non-limiting example of a pipeline with the keypoint network of FIG. 2 according to an example embodiment of this disclosure.

FIG. 5A is diagram of a non-limiting example of tracking 2D keypoints without using a keypoint heatmap according to an example embodiment of this disclosure.

FIG. 5B is diagram of a non-limiting example of tracking 2D keypoints via a keypoint heatmap according to an example embodiment of this disclosure.

FIG. 6 is a diagram of an example of a system that employs the semantic SLAM framework and the keypoint network according to an example embodiment of this disclosure.

FIG. 7 is a diagram of an example of mobile machine technology that includes the system of FIG. 6 according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

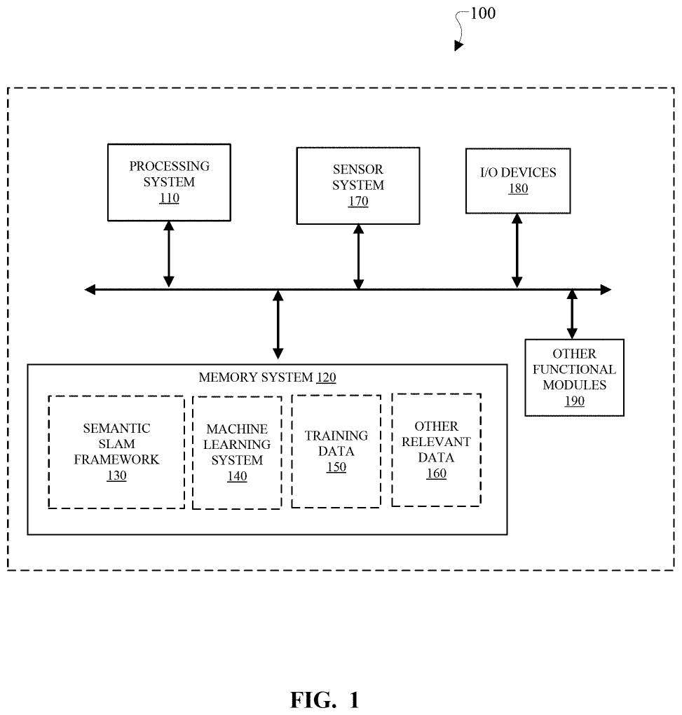

FIG. 1 is a diagram of a non-limiting example of a system 100, which relates to semantic simultaneous localization and mapping (SLAM) and 6DoF pose estimation. As a general overview, the system 100 is configured to provide a keypoint-based object-level SLAM framework that can provide globally consistent 6DoF pose estimates for symmetric and asymmetric objects alike. The system 100 is innovative in utilizing the camera pose data from SLAM to provide prior knowledge for tracking keypoints on symmetric objects and ensuring that new measurements are consistent with the current three-dimensional (3D) scene. The system 100 significantly outperforms existing online approaches of single and multiview 6DoF object pose estimation, and at a real-time speed.

The system 100 includes at least a processing system 110 with at least one processing device. For example, the processing system 110 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. As a non-limiting example, the processing system may include at least one GPU and at least one CPU, for instance, such that machine learning inference is performed by the GPU while other operations are performed by the CPU. The processing system 110 is operable to provide the functionalities of the semantic SLAM and 6DoF pose estimations as described herein.

The system 100 includes a memory system 120, which is operatively connected to the processing system 110. The memory system 120 includes at least one non-transitory computer readable storage medium, which is configured to store and provide access to various data to enable at least the processing system 110 to perform the operations and functionality, as disclosed herein. The memory system 120 comprises a single memory device or a plurality of memory devices. The memory system 120 may include electrical, electronic, magnetic, optical, semiconductor, electromagnetic, or any suitable storage technology that is operable with the system 100. For instance, in an example embodiment, the memory system 120 can include random access memory (RAM), read only memory (ROM), flash memory, a disk drive, a memory card, an optical storage device, a magnetic storage device, a memory module, any suitable type of memory device, or any number and combination thereof. With respect to the processing system 110 and/or other components of the system 100, the memory system 120 is local, remote, or a combination thereof (e.g., partly local and partly remote). For instance, in an example embodiment, the memory system 120 includes at least a cloud-based storage system (e.g. cloud-based database system), which is remote from the processing system 110 and/or other components of the system 100.

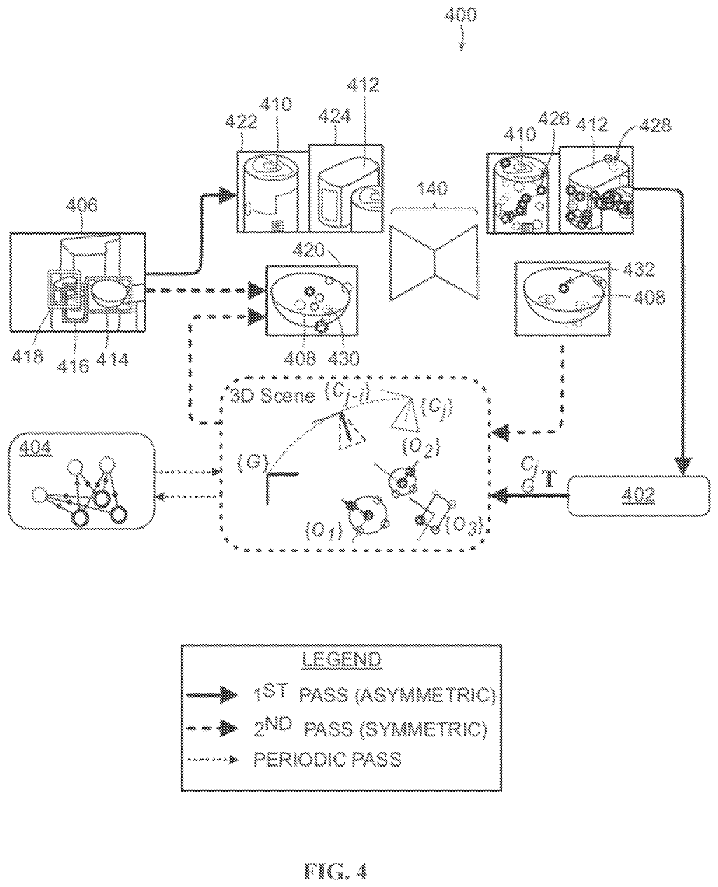

The memory system 120 includes at least a semantic SLAM framework 130, the machine learning system 140, training data 150, and other relevant data 160, which are stored thereon. The semantic SLAM framework 130 includes computer readable data with instructions, which, when executed by the processing system 110, is configured to train, deploy, and/or employ one or more machine learning systems 140. The computer readable data can include instructions, code, routines, various related data, any software technology, or any number and combination thereof. In an example embodiment, as shown in FIG. 4, the semantic SLAM framework 130 includes at least a front-end tracking module 402 and a back-end global optimization module 404. In this regard, the term, “module,” may refer to a software-based system, subsystem, or process, which is programmed to perform one or more specific functions. A module may include one or more software engines or software components, which are stored in the memory system 120 at one or more locations. In some cases, the module may also include one or more hardware components. The system 100 and/or the semantic SLAM framework 130 is not limited to these modules, but may include more or less modules provided that the semantic SLAM framework 130 is configured to provide the functionalities described in this disclosure.

In an example embodiment, the machine learning system 140 includes a convolutional neural network (CNN), any suitable encoding and decoding network, any suitable artificial neural network model, or any number and combination thereof. Also, the training data 150 includes at least a sufficient amount of sensor data (e.g. video data, digital image data, cropped image data, etc.), timeseries data, various loss data, various weight data, and various parameter data, as well as any related machine learning data that enables the system 100 to provide the semantic SLAM framework 130 and the trained machine learning system 140, as described herein. Meanwhile, the other relevant data 160 provides various data (e.g. operating system, machine learning algorithms, computer-aided design (CAD) databases, etc.), which enables the system 100 to perform the functions as discussed herein. As aforementioned, the system 100 is configured to train, employ, and/or deploy at least one machine learning system 140.

The system 100 is configured to include at least one sensor system 170. The sensor system 170 includes one or more sensors. For example, the sensor system 170 includes an image sensor, a camera, a radar sensor, a light detection and ranging (LIDAR) sensor, a thermal sensor, an ultrasonic sensor, an infrared sensor, a motion sensor, an audio sensor, any suitable sensor, or any number and combination thereof The sensor system 170 is operable to communicate with one or more other components (e.g., processing system 110 and memory system 120) of the system 100. For example, the sensor system 170 may provide sensor data, which is then processed by the processing system 110 to generate suitable input data (e.g., digital images) for semantic SLAM framework 1130 and the machine learning system 140. In this regard, the processing system 110 is configured to obtain the sensor data directly or indirectly from one or more sensors of the sensor system 170. The sensor system 170 is local, remote, or a combination thereof (e.g., partly local and partly remote). Upon receiving the sensor data, the processing system 110 is configured to process this sensor data (e.g., perform object detection via another machine learning system stored in memory system 120 to obtain bounding boxes and object classes) and provide this processed sensor data in a suitable format (e.g., digital image data, cropped image data, etc.) in connection with the semantic SLAM framework 130, the machine learning system 140, the training data 150, or any number and combination thereof

In addition, the system 100 may include at least one other component. For example, as shown in FIG. 1, the memory system 120 is also configured to store other relevant data 160, which relates to operation of the system 100 in relation to one or more components (e.g., sensor system 170, input/output (I/O) devices 180, and other functional modules 190). In addition, the system 100 is configured to include one or more I/O devices 180 (e.g., display device, keyboard device, microphone device, speaker device, etc.), which relate to the system 100. Also, the system 100 includes other functional modules 190, such as any appropriate hardware, software, or combination thereof that assist with or contribute to the functioning of the system 100. For example, the other functional modules 190 include communication technology that enables components of the system 100 to communicate with each other as described herein. In this regard, the system 100 is operable to at least train, employ, and/or deploy the machine learning system 140 (and/or the semantic SLAM framework 130), as described herein.

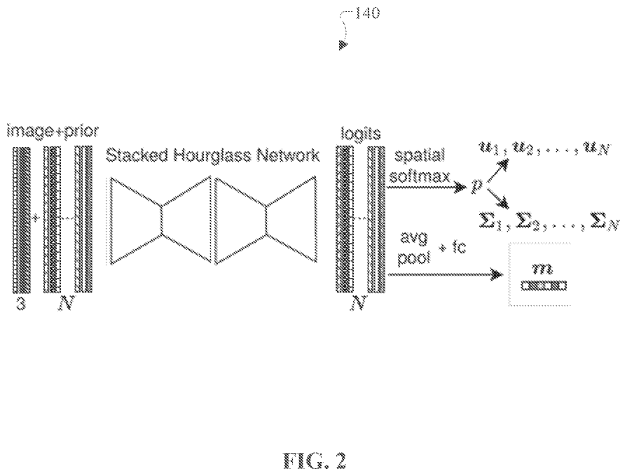

FIG. 2 is a diagram of an example of an architecture of the machine learning system 140 according to an example embodiment. In an example embodiment, the process of developing the machine learning system 140 includes obtaining digital images of objects. The process also includes defining 2D keypoints for each object in a digital image. The 2D keypoints may be generated manually or by any suitable computer technology (e.g., a machine learning system). In addition, the process includes classifying each object as being either asymmetric or symmetric. The symmetric/asymmetric classification may be performed manually or by any suitable computer technology (e.g., a machine learning system). Accordingly, the images of the objects together with their 2D keypoints and their asymmetric/symmetric classifications are used as training data to train the machine learning system 140.

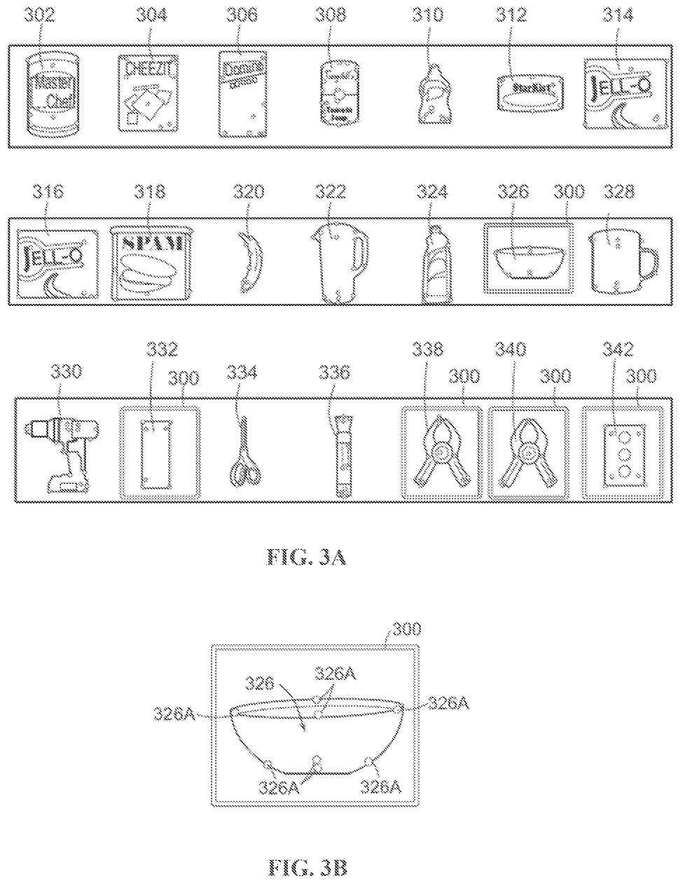

FIG. 3A is a diagram that provides non-limiting examples of various objects and their 2D keypoints. For example, the first row of objects includes a large can 302, a cracker box 304, a sugar bag 306, a medium can 308, a mustard bottle 310, a small can 312, and a first small box 314. The second row of objects includes a second small box 316, a rectangular can 318, a banana 320, a pitcher 322, a cleaning product 324, a bowl 326, and a mug 328. The third row of objects includes a power tool 330, a wood block 332, scissors 334, a marker 336, a first tool 338, a second tool 340, and a brick 342. Each of these objects include a set of 2D keypoints, which are displayed as small dots on that object.

FIG. 3B shows an enlarged view of an object, as a non-limiting example, in order to provide a better view of a set of 2D keypoints compared to that shown in FIG. 3A. More specifically, FIG. 3B shows an enlarged view of the bowl 326 along with its set of 2D keypoints 326A, which are shown as dots. In general, a set of 2D keypoints for an object may include one or more 2D keypoints, which are positioned on a selected part of that object. As shown in FIG. 3A and FIG. 3B, a keypoint may be disposed on a curved portion, a corner, an edge, or a noteworthy feature of an object. A keypoint generally refers to a control point or a feature point on an object.

In addition, FIG. 3A illustrates non-limiting examples of objects that are classified as symmetrical. For example, an object, which is displayed in the digital image as being symmetrical with respect to texture and symmetrical with respect to a rotational axis of the object, may be classified as symmetric. That is, although shape is a factor, the classification of an object as being symmetrical does not solely apply to a shape of an object. For instance, in FIG. 3A, each symmetrical object is identified by the presence of a bounding box 300. In this regard, the first row does not contain any objects that are classified as symmetrical as none of the objects in this row are displayed in bounding boxes 300. The second row contains one object that is classified as symmetrical. In particular, the bowl 326 is classified as a symmetrical object as indicated by the bounding box 300. Meanwhile, the third row includes four objects, which are classified as being symmetrical. The four symmetrical objects include the wood block 332, the first tool 338, the second tool 340, and the brick 342. In this regard, each of the aforementioned symmetrical objects in FIG. 3A, are symmetrical with respect to shape of that object, rotational axis of that object, and texture of that object.

FIG. 3A also illustrates non-limiting examples of objects that are classified as asymmetrical. Any object that is not symmetrical is classified as asymmetrical. Each asymmetrical object is identifiable in FIG. 3A by the absence of the bounding box 300. For example, each object in the first row is classified as being an asymmetrical object. That is, the asymmetrical objects in the first row include the large can 302, the cracker box 304, a sugar bag 306, a medium can 308, a mustard bottle 310, a small can 312, and a first small box 314. As shown in FIG. 3A, each object in the first row has a texture (e.g., product label displayed on product) that causes the object to be classified as asymmetrical. In this regard, while an object in the first row may have a symmetrical shape, the object is nevertheless classified as being asymmetrical due to the asymmetrical texture of that object. Furthermore, the asymmetrical objects in the second row include the second small box 316, the rectangular can 318, the banana 320, the pitcher 322, the cleaning product 324, and the mug 328. The asymmetrical objects in the third row include the power tool 330, the scissors 334, and the marker 336. In this regard, each of the aforementioned asymmetrical objects in FIG. 3A, are asymmetrical with respect to shape of that object, rotational axis of that object, texture of that object, or any number and combination thereof.

Referring back to FIG. 2, the machine learning system 140 may be referred to as a keypoint network. As shown in FIG. 2, the keypoint network is augmented to take an additional N channels as input for the prior keypoint input. If no prior is available, then the prior is all zeros. The keypoint network outputs an N-channel feature map corresponding to the raw logits that will become heatmaps for each keypoint. From there, a spatial softmax head predicts keypoints uᵢ and uncertainty Σᵢ, while an average pool head predicts the mask m for which keypoints are within the bounding box and belong to the object of interest.

The keypoint network is configured to predict the 2D keypoint coordinates together with their uncertainty. In addition, to make it able to provide consistent keypoint tracks for symmetric objects, the keypoint network optionally takes prior keypoint heatmap inputs that are expected to be somewhat noisy. The backbone architecture of the keypoint network is the stacked hourglass network with a stack of two hourglass networks. The machine learning system 140 includes a multi-channel keypoint parameterization due to its simplicity. With this formulation, each channel is responsible for predicting a single keypoint, and all of the keypoints for the dataset are combined into one output tensor, thereby allowing a single keypoint network to be used for all of the objects.

Given the image and prior input cropped to a bounding box and resized to a static input resolution, the keypoint network predicts a N×H/d×W/d tensor p, where H×W is the input resolution, d is the downsampling ratio (e.g., four), and N is the total number of keypoints for the dataset. From p, a set of N 2D keypoints {u₁, u₂, . . . , u_{N}}, 2×2 covariance matrices {Σ₁, Σ₂, . . . , Σ_{N}} are predicted. A binary vector m∈[0,1]^{N} is also predicted from the average pooled raw logits of p, which is trained to decide which keypoints belong to the object and are within the bounding box. Note that the keypoint network is trained to still predict occluded keypoints. Every channel of p, pᵢ is enforced to be a 2D probability mass by utilizing a spatial softmax. The predicted keypoint is taken as the expected value of 2D coordinates over this probability mass uᵢ=Σ_{u,v}pᵢ(u,v)[u v]^{T}. Unlike the non-differentiable argmax operation, this allows us to use the keypoint coordinate directly in the loss function, which relates to the uncertainty estimation.

Also, to efficiently track the keypoints over time during deployment, the system 100 is configured to obtain keypoint predictions having a symmetry hypothesis that is consistent with the 3D scene. The machine learning system 140 includes N extra channels as input to the keypoint network which contain a prior detection of the object's keypoints. To create the training prior, the 3D keypoints are projected into the image plane with a perturbed ground truth object pose δT,_{O}^{C}T in order to make the keypoint network robust to noisy prior detections, place the keypoints in the correct channel, and set the heatmap to a 2D Gaussian with a fixed σ=15.

A set of symmetry transforms, S={_{S}_{₁}^{O}T, _{S}_{₂}^{O}T, . . . , _{S}_{_{M}}^{O}T} are available for each object (discretized for objects with continuous axes of symmetry). Each _{S}_{ₘ}^{O}T∈S, when applied to the corresponding object CAD model, makes the rendering look (nearly) exactly the same, and in practice, these transforms can be manually chosen fairly easily. When the prior is given to the keypoint network during training, a random symmetry transform is selected and applied to the ground truth keypoint label in order to help the keypoint network learn to follow the prior.

Since a prior for the initial detection may not be obtained, the system 100 is configured to predict initial keypoints for symmetric objects when the prior is not available. For this reason, during training, the keypoint network is given a prior detection only half of the time. Of course the question arises of how to detect the initial keypoints for symmetric objects without the prior. The ground truth pose cannot simply be used to create the keypoint label since many images will look the same but with different keypoint labels, thereby creating an ill-posed one-to-many mapping. As opposed to the mirroring technique and additional symmetry classifier, the system 100 utilizes the set of symmetry transforms. So, when the prior is not given to the keypoint network during training, the system 100 alleviates the ill-posed problem by choosing the symmetry for keypoint labels that brings the 3D keypoints closest (in orientation) to those transformed into a canonical view {Oc} in the camera frame:

$${}_{S}^{O} T = {argmin}_{s {}_{m}^{o} T ∈ s} \frac{1}{K} {\sum }_{k = 1}^{K} {‖ {c}_{\tilde{{p}_{k}}} - {c}_{{\tilde{p}}_{k}^{c}} ‖}_{2} \qquad [ 1 ]$$

$${c}_{{p}_{k}} = {}_{o}^{c} R ( {s}_{m}^{O} {R}^{O} {p}_{k} + {}_{□}^{O} p {s}_{m} )$$

$${c}_{{p}_{k}^{c}} = {o}_{c}^{C} {R}^{O} {p}_{k}$$

In equation 1,

$${\tilde{p}}_{k} = {p}_{k} - \frac{1}{K} {\sum }_{k = 1}^{K} {p}_{k}$$

denotes the kth point of a mean-subtracted point cloud.

FIG. 4 is a flow diagram of a non-limiting example of a pipeline 400 that provides multi-view 6DoF object pose data and camera pose data during inference time according to an example embodiment. In this regard, the system 100 jointly estimates object pose data and camera pose data while accounting for the symmetry of detected objects. More specifically, as shown in FIG. 4, the pipeline 400 involves at least two passes to deal with asymmetric and symmetric objects separately. In the first pass, one or more asymmetric objects are tracked from the 3D scene to estimate the camera pose. In the second pass, the estimated 3D keypoints for symmetric objects are projected into the current camera view to be used as the prior knowledge to help predict keypoints for these objects that are consistent with the 3D scene. The pipeline 400 includes two modules, a front-end tracking module 402 using the keypoint network, and a back-end global optimization module 404 to refine the object and camera pose estimates. As a result, the system 100 can operate on sequential inputs and estimate the current state in real time for the use of an operator or robot requiring object and camera poses in a feedback loop.

As shown in FIG. 4, the system 100 is configured to obtain at least one image with at least one object together with a corresponding bounding box and a corresponding object label (i.e., label to identify the object) for the pipeline 400. Each bounding box is selected for one stream among two different streams: (i) a first stream for asymmetric objects and first-time detections of symmetric ones, and (ii) a second stream for symmetric objects that already have 3D estimates. The first stream sends the images, cropped at the bounding boxes, to the keypoint network without any prior to detect keypoints and uncertainty. These keypoints are then used to estimate the pose of each object _{O}^{C}Tₚₙₚ in the current camera frame by using Perspective-n-Point (PnP) with random sample consensus (RANSAC). With the PnP poses of each asymmetric object in the current camera frame, the next step is to obtain a coarse estimate of the current camera pose in the global frame.

Besides the first image, whose camera frame becomes the global reference frame {G}; the system 100 is configured to estimate the camera pose _{G}^{C}T with the set of object PnP poses and the current estimates of the objects in the global frame. For each asymmetric object that is both detected in the current frame with a successful PnP pose _{O}^{C}Tₚₙₚ and has an estimated global pose _{O}^{G}T, the system 100 is configured to create a hypothesis about the current camera's pose as _{G}^{C}T_{hyp}=_{O}^{C}T_{pnp O}^{G}T⁻¹ and then project the 3D keypoints from all objects that have both a global 3D estimate and detection in the current image into the current image plane with this camera pose, and count inliers with a χ² test using the detected keypoints and uncertainty. The system 100 is configured to take the camera pose hypothesis with the most inliers as the final _{G}^{C}T, and reject any hypothesis that has too few. After this, any objects that have valid PnP poses but are not yet initialized in the scene are given an initial pose _{O}^{G}T=_{G}^{C}T⁻¹_{O}^{C}Tₚₙₚ. With a rough estimate of the current camera, the system 100 is configured to create the prior detections for the keypoints of symmetric objects by projecting the 3D keypoints for these objects into the current image, and constructing the prior keypoint heatmaps for keypoint network input.

Since each object is initialized with a PnP pose, it is possible that the initialization can be very poor from a PnP failure, and, if the pose is bad enough (e.g., off by a large orientation error), optimization cannot fix it due to only reaching local minima. To address this issue, the system 100 is configured to check if the PnP pose from the current image yields more inliers over the last few views than the current estimated pose, and, if this is true, then the system 100 is configured to re-initialize the object with the new pose. After this, the system 100 is configured to perform a quick local refinement of the camera pose by fixing the object poses and optimizing just the current camera to better register it into the scene.

The back-end global optimization module 404 runs periodically to refine the whole scene (object and camera poses) based on the measurements from each image. Rather than reduce the problem to a pose graph (i.e., using relative pose measurements from PnP), the system 100 is configured to keep the original noise model of using the keypoint detections as measurements, which allows us to weight each residual with the covariance prediction from the network. The global optimization problem is formulated by creating residuals that constrain the pose _{G}^{C}^{ⱼ}T of image j and the pose _{O}_{ₗ}^{G}T of object [symbol] with the kth keypoint

r_{j,l,k}=u_{j,l,k}−Π_{j,l}( [symbol] ) [2]

where Π_{j,l} is the perspective projection function for the bounding box of object [symbol] in image j. Thus the full problem becomes to minimize the cost over the entire scene.

C=Σ_{j,l,k}S_{j,l,k}ρ_{H}(r_{j,l,k}^{T}Σ_{j,l,k}⁻¹r_{j,l,k}) [3]

where Σ_{j,l k} is the 2×2 covariance matrix for the keypoint u_{j,l,k}, ρ_{H} is the Huber norm which reduces the effect of outliers during the optimization steps, and s_{j,l,k}∈{0,1} is a binary variable that is 1 if the measurement was deemed an inlier before the optimization started, and 0 otherwise. Both ρ_{H} and s_{j,l,k} use the same outlier threshold τ, which is derived from the 2-dimensional λ2 distribution, and is always set to the 95% confidence threshold τ=5.991. Thus, the outlier threshold does not need to be manually tuned as long as the covariance matrix Σ_{j,l,k} can properly capture the true error of keypoint u_{j,l,k}.

To provide robustness to the optimization against outliers, the process is actually split into four sub-optimizations, where the system 100 is configured to re-classify inliers and outliers by recomputing before each sub-optimization starts. This way, outliers can become inliers again after optimization updates the variables, and inliers can become outliers. Halfway through the optimization, the system 100 may remove the Huber norm since most, if not all, of the outliers have already been excluded.

Referring to the use case shown in FIG. 4, as a non-limiting example, the system 100 (e.g., the semantic SLAM framework 130, the processing system 110, and the machine learning system 140) is configured to implement and perform the operations of the pipeline 400. For example, the processing system 110 (e.g. a processor) is configured to receive a digital image 406 from the sensor system 170 (e.g., a camera). The image 406 displays a scene, which may include one or more objects. For instance, in the non-limiting example shown in FIG. 4, the image 406 displays a scene with a first object 408 (e.g., the bowl 326 denoted as O₁), a second object 410 (e.g., the medium can 308 denoted as O₂), and a third object 412 (e.g., the substantially rectangular can 318 denoted as O₃) on a table surface. In addition, each object is provided in a corresponding bounding box. In this example, each bounding box is generated during an object detection process. The object detection process is performed by another machine learning system to prepare the image 406 as input to the pipeline 400. Each bounding box identifies an object and includes an object class (e.g., bowl class) identifying that object. For example, the first object 408 is bounded by the first bounding box 414 and associated with the bowl class. The second object 410 is bounded by the second bounding box 416 and associated with the medium can class. The third object 412 is bounded by the third bounding box 418 and associated with the rectangular can class. The system 100 crops the image at each of the bounding boxes to create cropped images, such as the first cropped image 420, the second cropped image 422, and the third cropped image 424. Also, each object class is associated with a symmetric label or an asymmetric label to assist with the creation of the two streams, as shown in FIG. 4. More specifically, for an image 406, the system 100 is configured to create a first stream for one or more of asymmetric objects (e.g., the second object 410 and the third object 412) and a second stream for one or more symmetric objects (e.g., the first object 408). The system 100 passes the first stream during the first pass of the pipeline 400 and then passes the second stream during the second pass of the pipeline 400.

Prior to the first pass, the system 100 is initialized with an initial pass through the pipeline 400. More specifically, during the initial pass, the machine learning system 140 is configured to receive a cropped image of each object in an image taken at time t₀. In this case, the initial pass includes a stream that includes each object in that image (e.g., both asymmetrical and symmetrical objects). In response to each cropped image, the machine leaning system 140 (e.g., the keypoint network) is configured to generate 2D keypoints for each object at time t₀. The system is also configured to generate object pose data at time t₀ for each object via a PnP process using the 2D keypoints for that object and 3D keypoints corresponding to a 3D model (e.g., CAD model) for that object. In this regard, the system 100 (e.g., memory system 120) includes a CAD database, which includes CAD models of various objects including each of the objects in the image 406. The CAD database also includes a set of 3D keypoints for each CAD model. In addition, during this initial pass, the camera pose data is set to be the global reference frame {G} and is not calculated in this instance. Also, coordinate data is generated for each object based on the object pose data with respect to the global reference frame. After the initial pass is performed, then the system 100 is configured to perform the first pass and the second pass of the pipeline 400.

With respect to the first pass of the pipeline 400, the machine learning system 140 receives the first stream of one or more images of one or more objects, which are identified as asymmetrical. In this case, the machine learning system 140 receives the second cropped image 422 and the third cropped image 424, which are associated with asymmetric labels, as input. In response to receiving an image as input, the machine learning system 140 is configured to generate 2D keypoints for the object in that image. The machine learning system 140 is agnostic to the choice of keypoint. For example, FIG. 4 shows a visualization of a set of 2D keypoints 426 for the second object 410 in the second cropped image 422 and a visualization a set of 2D keypoints 428 for the third object 412 in the third cropped image 424. In FIG. 4, each 2D keypoint is represented as a dot, which is circled with a circle to represent a level of uncertainty. The front-end tracking module 402 is configured to receive each set of 2D keypoints of the first stream. Each set of 2D keypoints is then used to estimate object pose data for that corresponding object in the current camera frame of the image 406 via PnP with RANSAC. The object pose data is relative to a camera center of the camera. In this regard, the system 100 is configured to generate the object pose data by using the 2D keypoints of that object as obtained from the machine learning system 140 together with 3D keypoints of the object from a 3D model (e.g., a CAD model) of that object.

With the object pose data of each asymmetric object in the current camera frame, the system 100 is configured to obtain a coarse estimate of the current camera pose in the global frame. More specifically, for instance, if the current frame is not the first frame, based on the correspondence between all of the 2D keypoints of the asymmetric objects and their previously recovered 3D locations, then the current camera pose is also estimated through another PnP process. In this regard, the system 100 is configured to generate camera pose data via PnP using various keypoint data relating to the set of asymmetric objects in the first stream. More specifically, the system 100 is configured to generate camera pose data via PnP using the set of 2D keypoints 426 of the second object 410 at time the set of 2D keypoints 428 of the third object 412 at time tⱼ a prior set of 3D keypoints of the second object O₂ in world coordinates at time tⱼ₋₁, and a prior set of 3D keypoints of the third object O₃ in world coordinates at time tⱼ₋₁. The prior set of 3D keypoints of the second object O₂ in world coordinates at time tⱼ₋₁ and the prior set of 3D keypoints of the third object O₃ in world coordinates at time tⱼ₋₁ may be obtained from the memory system 120 as prior knowledge that was given or previously generated.

With the camera pose data, the system 100 is configured to estimate the detections for 2D keypoints of each symmetric object at time tⱼ by projecting the prior set of 3D keypoints at time tⱼ₋₁ for each symmetric object into the current image, and constructing a keypoint heatmap for each symmetric object. For example, in FIG. 4, the system 100 is configured to generate a keypoint heatmap 430 using the camera pose data in world coordinates at time tⱼ and a prior set of 3D keypoints for the second object O₂ in world coordinates at time The prior set of 3D keypoints for the second object at time may be obtained from the memory system 120 as prior knowledge that was given or previously generated. In this regard, FIG. 4 merely shows a visualization of a keypoint heatmap 430, which is represented as various circles that are superimposed on the first object 408 of the cropped image 420 for convenience and ease of understanding.

In addition, the system 100 is configured to generate corresponding coordinate data of the second object 410 in world coordinates at time tⱼ using the object pose data of that second object 410 at time tⱼ and the camera pose data of the camera at time The system 100 is also configured to generate corresponding coordinate data of the third object 412 in world coordinates at time tⱼ using the object pose data of that third object 412 at time tⱼ and the camera pose data of the camera at time tⱼ. Upon completing the first pass of the pipeline 400, the system 100 is configured to provide at least the camera pose data of the camera in world coordinates, coordinate data of the second object 410 in world coordinates, and coordinate data of the third object 412 in world coordinates. After handling each asymmetric object in the image 406, then the system 100 is configured to perform the second pass of the pipeline 400 with the camera pose data in world coordinates.

With respect to the second pass of the pipeline 400, the machine learning system 140 receives the second stream of one or more images of one or more objects, which are identified as symmetrical. In this case, the first stream only includes a single symmetrical object (i.e., the first object 408). The machine learning system 140 thus receives the first cropped image 420 of the first object 408 as input. In addition, the machine learning system 140 also receives the keypoint heatmap 430 as input. In this regard, the machine learning system 140 is configured to generate 2D keypoints for the first object 408 in response to the first cropped image 420 and the keypoint heatmap 430. In this regard, FIG. 4 shows a visualization of a set of 2D keypoints 432 for the first object 408 in the first cropped image 420. In FIG. 4, each 2D keypoint 432 is represented as a dot, which is encircled by a circle to represent a level of uncertainty. The system 100 is also configured to generate the object pose data of the first object 408 via PnP by using the 2D keypoints of that first object 408 together with 3D keypoints of a CAD model of that first object 408.

In addition, the system 100 is configured to generate corresponding coordinate data of the first object 408 in world coordinates at time tⱼ using the object pose data of that first object 408 and the camera pose data in world coordinates at time tⱼ. As aforementioned, in this example, the camera pose data at time tⱼ is generated during the first pass. Upon completing the second pass of the pipeline 400, the system 100 is configured to provide at least the coordinate data of the first object 408 in world coordinates at time tⱼ. After handling each symmetric object taken from the image 406, the system 100 is configured to handle the next image or the next frame. In this regard, the system 100 is configured to update and track 6DoF camera pose estimations in world coordinates. Also, the system 100 is configured to update and track 6DoF object pose estimations of various objects in world coordinates.

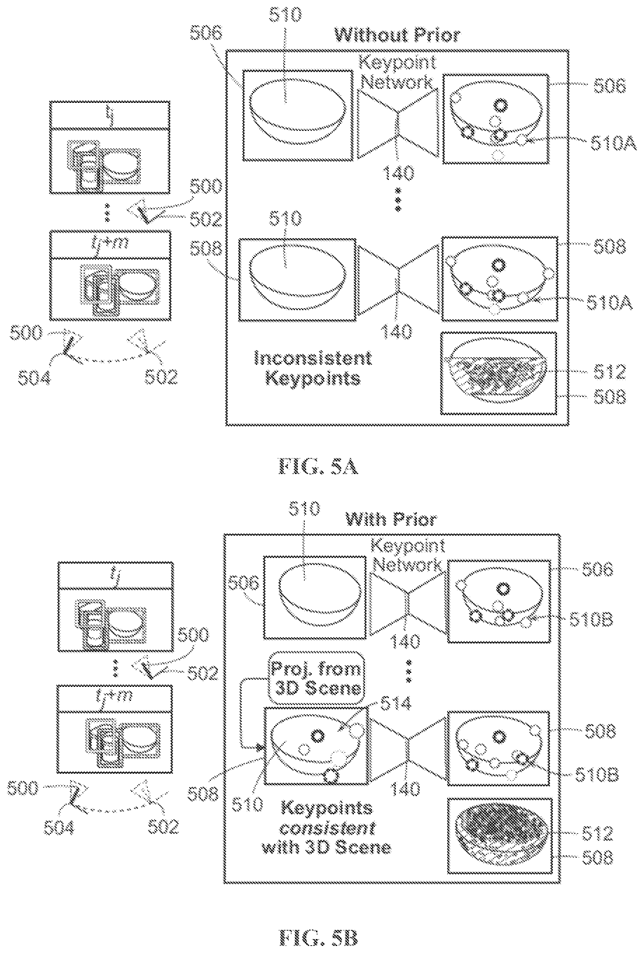

FIG. 5A and FIG. 5B, when compared, highlight a number of advantages of the system 100 (e.g., the semantic SLAM framework 130 and the machine learning system 140) according to an example embodiment. As a reference for comparison, FIG. 5A illustrates a case in which only the current image 508 serves as input to the machine learning system 140 (e.g., the keypoint network). In this case, the system 100 is not able to consistently track a set of 2D keypoints 510A for a symmetrical object 510 (e.g. symmetric with respect to texture and a rotational axis of the object) across multiple image frames (e.g. image 506 and image 508) as the camera 500 moves from a first camera pose 502 at time tⱼ to a second camera pose 504 at time tⱼ₊ₘ. The inconsistency of the tracking of the set of 2D keypoints 510A across these image frames is demonstrated upon overlaying a CAD model 512 of that symmetrical object 510 according to the set of 2D keypoints 510A on that current image 508. As shown in FIG. 5A, there is some confusion as to the proper locations of a number of the 2D keypoints 510A for the symmetrical object 510 on that current image 508.

In contrast, FIG. 5B illustrates a case in which the current image 508 and a keypoint heatmap 514 serve as input to the machine learning system 140 (e.g., the keypoint network). In this case, the system 100 is configured to track a symmetric object 510 (e.g. a bowl) of a scene in a simple and effective manner. More specifically, the system 100 is configured to wait to detect a set of 2D keypoints 510B for a symmetric object 510 until the camera pose data for the current camera pose 504 is determined after the first pass of the pipeline 400. Upon generating the camera pose data for the current camera pose 504, the system 100 then uses the current camera pose data with prior 3D keypoints of the object at time tⱼ₋₁ to generate a 2D keypoint heatmap 514 for the keypoint network. The keypoint network is enabled to generate a set of 2D keypoints for the symmetric object 510 in response to the current image 508 and the 2D keypoint heatmap 514. As shown in FIG. 5B, the system 100 is configured to track the symmetric object 510 consistently across images or image frames as demonstrated upon overlaying the CAD model 512 of that symmetrical object 510 according to the set of 2D keypoints 510B on that current image 508.

FIG. 6 is a diagram of a system 600, which is configured to include at least the semantic SLAM framework 130 and the trained machine learning system 140 along with corresponding relevant data according to an example embodiment. In this regard, the system 600 includes at least a sensor system 610, a control system 620, and an actuator system 630. The system 600 is configured such that the control system 620 controls the actuator system 630 based on the input received from the sensor system 610. More specifically, the system 600 includes at least one sensor system 610. The sensor system 610 includes one or more sensors. For example, the sensor system 610 includes an image sensor, a camera, a radar sensor, a LIDAR sensor, a thermal sensor, an ultrasonic sensor, an infrared sensor, a motion sensor, an audio sensor, any suitable sensor, or any number and combination thereof. The sensor system 610 is operable to communicate with one or more other components (e.g., processing system 640 and memory system 660) of the system 600. In this regard, the processing system 640 is configured to obtain the sensor data directly or indirectly from one or more sensors of the sensor system 610.

The control system 620 is configured to receive sensor data from the sensor system 610. The processing system 640 includes at least one processor. For example, the processing system 640 includes an electronic processor, a CPU, a GPU, a microprocessor, a FPGA, an ASIC, processing circuits, any suitable processing technology, or any number and combination thereof. Upon receiving sensor data received from the sensor system 610, the processing system 640 is configured to process the sensor data to provide suitable input data, as previously described, to the semantic SLAM framework 130 and the machine learning system 140. The processing system 640, via the semantic SLAM framework 130 and the machine learning system 140, is configured to generate coordinate data for the camera and the objects in world coordinates as output data. In an example embodiment, the processing system 640 is operable to generate actuator control data based on this output data. The control system 620 is configured to control the actuator system 630 according to the actuator control data.

The memory system 660 is a computer or electronic storage system, which is configured to store and provide access to various data to enable at least the operations and functionality, as disclosed herein. The memory system 660 comprises a single device or a plurality of devices. The memory system 660 includes electrical, electronic, magnetic, optical, semiconductor, electromagnetic, any suitable memory technology, or any combination thereof. For instance, the memory system 660 may include RAM, ROM, flash memory, a disk drive, a memory card, an optical storage device, a magnetic storage device, a memory module, any suitable type of memory device, or any number and combination thereof. In an example embodiment, with respect to the control system 620 and/or processing system 640, the memory system 560 is local, remote, or a combination thereof (e.g., partly local and partly remote). For example, the memory system 660 is configured to include at least a cloud-based storage system (e.g. cloud-based database system), which is remote from the processing system 640 and/or other components of the control system 620.

The memory system 660 includes the semantic SLAM framework 130 and the trained machine learning system 140. Also, in an example, the memory system 660 includes an application program 680. In this example, the application program 680 relates to computer vision and mapping. The application program 680 is configured to ensure that the processing system 640 is configured to generate the appropriate input data for the semantic SLAM framework 130 and the machine learning system 140 based on sensor data received from the sensor system 610. In addition, the application program 680 is configured to use the coordinate data of the camera and the coordinate data of the objects in world coordinates to contribute to computer vision and/or mapping. In general, the application program 680 enables the semantic SLAM framework 130 and the trained machine learning system 140 to operate seamlessly as a part of the control system 620.

Furthermore, as shown in FIG. 6, the system 600 includes other components that contribute to operation of the control system 620 in relation to the sensor system 610 and the actuator system 630. For example, as shown in FIG. 6, the memory system 660 is also configured to store other relevant data 690, which relates to the operation of the system 600. Also, as shown in FIG. 6, the control system 620 includes the I/O system 670, which includes one or more I/O devices that relate to the system 600. Also, the control system 620 is configured to provide other functional modules 650, such as any appropriate hardware technology, software technology, or any combination thereof that assist with and/or contribute to the functioning of the system 600. For example, the other functional modules 650 include an operating system and communication technology that enables components of the system 600 to communicate with each other as described herein. Also, the components of the system 600 are not limited to this configuration, but may include any suitable configuration as long as the system 600 performs the functionalities as described herein. Accordingly, the system 600 is useful in various applications.

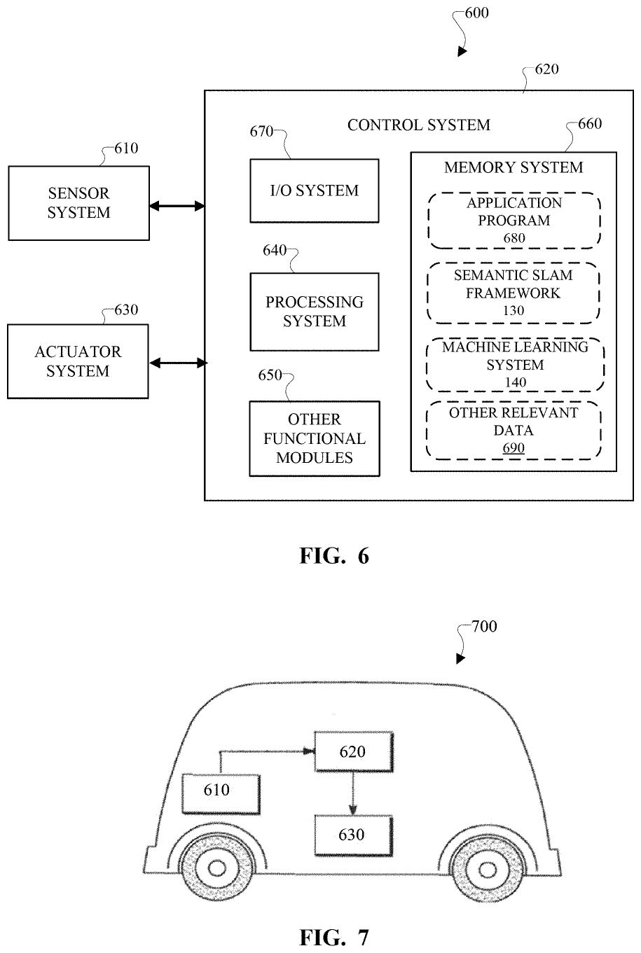

FIG. 7 is a diagram of an example of an application of at least the semantic SLAM framework 130 and the trained machine learning system 140 with respect to mobile machine technology according to an example embodiment. The mobile machine technology may include a vehicle, a robot, or any machine that is mobile and at least partially autonomous. For instance, in this case, the mobile machine technology includes a vehicle 700, which is at least partially autonomous or fully autonomous. In FIG. 7, the vehicle 700 includes the sensor system 610, which is configured to generate sensor data. Upon receiving the sensor data, the control system 620 is configured to process the sensor data and provide the aforementioned preprocessed digital image data as input to the semantic SLAM framework 130 and the trained machine learning system 140 (e.g., the keypoint network). In response to this input, the control system 620, via the semantic SLAM framework 130 and the trained machine learning system 140, is configured to generate world coordinates for the camera pose and each object pose as output data. In response to the output data, the processing system 640, via the application program 680, is configured to use this output data to contribute to computer vision, mapping, route planning, navigation, motion control, any suitable application, or any number and combination thereof. In addition, the control system 620 is configured to generate actuator control data, which is also based on the output data. For instance, as a non-limiting example, the actuator system 630 is configured to actuate at least the braking system to stop the vehicle 700 upon receiving the actuator control data. In this regard, the actuator system 630 is configured to include a braking system, a propulsion system, an engine, a drivetrain, a steering system, any suitable actuator, or any number and combination of actuators of the vehicle 700. The actuator system 630 is configured to control the vehicle 700 so that the vehicle 700 follows rules of the roads and avoids collisions based at least on the output data provided by the processing system 110 via the semantic SLAM framework 130 and the trained machine learning system 140.

As described in this disclosure, the system 100 provides a number of advantages and benefits. For example, the system 100 is configured to provide a keypoint-based object SLAM system that jointly estimates the globally-consistent object pose data and camera pose data in real time even in the presence of incorrect detections and symmetric objects. In addition, the system 100 is configured to predict and track semantic keypoints for symmetric objects, thereby providing a consistent hypothesis about the symmetry over time by exploiting the 3D pose information from SLAM. The system 100 is also configured to train the keypoint network to estimate the covariance of its predictions in such a way that the covariance quantifies the true error of the keypoints. The system 100 is configured to show that utilizing this covariance in the SLAM system significantly improves the object pose estimation accuracy.

Also, the system 100 is configured to handle keypoints of symmetric objects in an effective manner for multi-view 6D object pose estimation. More specifically, the system 100 uses pose estimation data of one or more asymmetric objects to improve pose estimation data of one or more symmetric objects. Compared to a prototypical keypoint-based method, the system 100 provides greater consistency in semantic detection across frames, thereby leading to more accurate final results. The system focuses on providing a solution in real-time and is over 10 times faster than iterative methods, which are impractically slow.

Furthermore, benefiting from the prior knowledge, the machine learning system 140 is configured to predict 2D keypoints of various objects with respect to sequential frames while providing more semantic consistency for symmetric objects such that the overall fusion of the multi-view results is more accurate. More technically, the variance of the keypoint heatmap is determined by the uncertainty of keypoints estimated from the machine learning system 140 and fused from multi-view previous. Advantageously, the machine learning system 140 is trained to predict the semantic 2D keypoints and also the uncertainty associated with these semantic 2D keypoints.

Also, the system 100 provides a configuration, which advantageously includes front-end processing and back-end processing. More specifically, the front-end processing is responsible for processing the incoming frames, running the keypoint network, estimating the current camera pose, and initializing new objects. Meanwhile, the back-end processing is responsible for refining the camera and object poses for the whole scene. In this regard, the system 100 advances existing methods in handling 6DoF object pose estimations for symmetric objects. The system 100 is configured to provide keypoint detection of asymmetric objects into a SLAM system such that a new camera pose can be estimated. Given the new camera pose, the previous detection of keypoints of symmetric objects can be projected onto the current frame to assist with the keypoint detection on the current frame. Given the prior knowledge on the previous determined symmetry, the keypoint estimation results across multi-frames can be more semantically consistent. Moreover, the 6DoF pose estimations may be used in a variety of applications, such as autonomous driving, robots, security systems, manufacturing systems, augmented reality systems, as well as a number of other technologies that are not specifically mentioned herein.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A computer-implemented method for semantic localization of various objects, the method comprising:
obtaining an image that displays a scene with a first object and a second object;
generating a first set of two-dimensional (2D) keypoints corresponding to the first object;
generating first object pose data based on the first set of 2D keypoints;
generating camera pose data based on the first object pose data, the camera pose data corresponding to capture of the image;
generating a keypoint heatmap based on the camera pose data;
generating a second set of 2D keypoints corresponding to the second object based on the keypoint heatmap;
generating second object pose data based on the second set of 2D keypoints;
generating first coordinate data of the first object in world coordinates using the first object pose data and the camera pose data;
generating second coordinate data of the second object in the world coordinates using the second object pose data and the camera pose data;
tracking the first object based on the first coordinate data; and
tracking the second object based on the second coordinate data.

2. The computer-implemented method of claim 1, wherein:
the first object is classified as asymmetrical with respect to a first texture of the first object in the image and a first rotational axis of the first object; and
the second object is classified as symmetrical with respect to a second texture of the second object in the image and a second rotational axis of the second object.

3. The computer-implemented method of claim 1, further comprising:
cropping the image to generate a first cropped image that includes the first object,
wherein the first set of 2D keypoints is generated by a trained machine learning system in response to the first cropped image.

4. The computer-implemented method of claim 1, further comprising:
cropping the image to generate a second cropped image that includes the second object,
wherein the second set of 2D keypoints is generated by a trained machine learning system in response to the second cropped image and the keypoint heatmap.

5. The computer-implemented method of claim 1, wherein:
the keypoint heatmap includes another set of 2D keypoints of the second object on the image; and
the another set of 2D keypoints are estimated using the camera pose data and a prior set of three-dimensional (3D) keypoints of the second object.

6. The computer-implemented method of claim 1, further comprising:
obtaining a first set of three-dimensional (3D) keypoints of the first object from a first 3D model of the first object;
obtaining a second set of 3D keypoints of the second object from a second 3D model of the second object;
generating the first object pose data via a Perspective-n-Point (PnP) process that uses the first set of 2D keypoints and the first set of 3D keypoints; and
generating the second object pose data via the PnP process that uses the second set of 2D keypoints and the second set of 3D keypoints.

7. The computer-implemented method of claim 1, further comprising:
optimizing a cost of the scene based on the first object pose data, the second object pose data, and the camera pose data.

8. A system comprising:
an camera;
a processor in data communication with the camera, the processor being configured to receive a plurality of images from the camera, the processor being operable to:
obtain an image that displays a scene with a first object and a second object;
generate a first set of two-dimensional (2D) keypoints corresponding to the first object;
generate first object pose data based on the first set of 2D keypoints;
generate camera pose data based on the first object pose data, the camera pose data corresponding to capture of the image;
generate a keypoint heatmap based on the camera pose data;
generate a second set of 2D keypoints corresponding to the second object based on the keypoint heatmap;
generate second object pose data based on the second set of 2D keypoints;
generate first coordinate data of the first object in world coordinates using the first object pose data and the camera pose data;
generate second coordinate data of the second object in the world coordinates using the second object pose data and the camera pose data;
track the first object based on the first coordinate data; and
track the second object based on the second coordinate data.

9. The system of claim 8, wherein:
the first object is classified as asymmetrical with respect to a first texture of the first object in the image and a first rotational axis of the first object; and
the second object is classified as symmetrical with respect to a second texture of the second object in the image and a second rotational axis of the second object.

10. The system of claim 8, wherein the processor is further operable to:
crop the image to generate a first cropped image that includes the first object,
wherein the first set of 2D keypoints is generated by a trained machine learning system in response to the first cropped image.

11. The system of claim 8, wherein the processor is further operable to:
crop the image to generate a second cropped image that includes the second object,
wherein the second set of 2D keypoints is generated by a trained machine learning system in response to the second cropped image and the keypoint heatmap.

12. The system of claim 8, wherein:
the keypoint heatmap includes another set of 2D keypoints of the second object on the image; and
the another set of 2D keypoints are estimated using the camera pose data and a prior set of three-dimensional (3D) keypoints of the second object.

13. The system of claim 8, wherein the processor is further operable to:
obtain a first set of three-dimensional (3D) keypoints of the first object from a first 3D model of the first object;
obtain a second set of 3D keypoints of the second object from a second 3D model of the second object;
generate the first object pose data via a Perspective-n-Point (PnP) process that uses the first set of 2D keypoints and the first set of 3D keypoints; and
generate the second object pose data via the PnP process that uses the second set of 2D keypoints and the second set of 3D keypoints.

14. The system of claim 8, wherein the processor is further operable to:
optimize a cost of the scene based on the first object pose data, the second object pose data, and the camera pose data.

15. One or more non-transitory computer readable storage media storing computer readable data with instructions that when executed by one or more processors cause the one or more processors to perform a method that comprises:
obtaining an image that displays a scene with a first object and a second object;
generating a first set of two-dimensional (2D) keypoints corresponding to the first object;
generating first object pose data based on the first set of 2D keypoints;
generating camera pose data based on the first object pose data, the camera pose data corresponding to capture of the image;
generating a keypoint heatmap based on the camera pose data;
generating a second set of 2D keypoints corresponding to the second object based on the keypoint heatmap;
generating second object pose data based on the second set of 2D keypoints;
generating first coordinate data of the first object in world coordinates using the first object pose data and the camera pose data;
generating second coordinat data of the second object in the world coordinates using the second object pose data and the camera pose data;
tracking the first object based on the first coordinate data; and
tracking the second object based on the second coordinate data.

16. The one or more non-transitory computer readable storage media of claim 15, wherein:
the first object is classified as asymmetrical with respect to a first texture of the first object in the image and a first rotational axis of the first object; and
the second object is classified as symmetrical with respect to a second texture of the second object in the image and a second rotational axis of the second object.

17. The one or more non-transitory computer readable storage media of claim 15, wherein the method further comprises:
cropping the image to generate a first cropped image that includes the first object,
wherein the first set of 2D keypoints is generated by a trained machine learning system in response to the first cropped image.

18. The one or more non-transitory computer readable storage media of claim 15, wherein the method further comprises:
cropping the image to generate a second cropped image that includes the second object,
wherein the second set of 2D keypoints is generated by a trained machine learning system in response to the second cropped image and the keypoint heatmap.

19. The one or more non-transitory computer readable storage media of claim 15, wherein:
the keypoint heatmap includes another set of 2D keypoints of the second object on the image; and
the another set of 2D keypoints are estimated using the camera pose data and a prior set of three-dimensional (3D) keypoints of the second object.

20. The one or more non-transitory computer readable storage media of claim 15, wherein the method further comprises:
obtaining a first set of three-dimensional (3D) keypoints of the first object from a first 3D model of the first object;
obtaining a second set of 3D keypoints of the second object from a second 3D model of the second object;
generating the first object pose data via a Perspective-n-Point (PnP) process that uses the first set of 2D keypoints and the first set of 3D keypoints; and
generating the second object pose data via the PnP process that uses the second set of 2D keypoints and the second set of 3D keypoints.
